(19) United States
(12) Patent Application Publication
(10) Pub. No.: US 2019/0148763 A1
(43) Pub. Date: May 16, 2019

(54) SELF-CHARGING AND/OR SELF-CYCLING ELECTROCHEMICAL CELLS

(71) Applicants: BOARD OF REGENTS, THE UNIVERSITY OF TEXAS SYSTEM, Austin, TX (US); UNIVERSIDADE DO PORTO, PORTO (PT); LNEG-LABORATORIO NACIONAL DE ENERGIA E GEOLOGIA, S. MAMEDE INFESTA (PT)

(72) Inventors: John B. Goodenough, Austin, TX (US); Maria Helena Sousa Soares De Oliveira Braga, Austin, TX (US); Jose Jorge Do Amaral Ferreira, S. Mamede Infesta (PT); Joana Cassilda Rodrigues Espain De Oliveira, Porto (PT); Andrew Murchison, San Jose, CA (US)

(21) Appl. No.: 16/243,792

(22) Filed: Jan. 9, 2019

Related U.S. Application Data
(63) Continuation of application No. PCT/US2017/041382, filed on Jul. 10, 2017.
Application No. PCT/US2017/041382 is a continuation of application No. 15/478,099, filed on Apr. 3, 2017.
(60) Provisional application No. 62/360,853, filed on Jul. 11, 2016.

(51) Int. Cl. H01M 10/054; H01M 10/052; H01M 4/38; H01M 10/0562; H01M 4/62

(52) U.S. Cl. CPC H01M 10/054; H01M 10/052; H01M 4/381; H01M 2004/027; H01M 4/38; H01M 4/625; H01M 10/0562

(57) ABSTRACT

The present disclosure provides an electrochemical cell including a solid glass electrolyte including an alkali metal working ion that is conducted by the electrolyte, and a dipole, an anode having an effective anode chemical potential μ_{A}, and a cathode having an effective cathode chemical potential μ_{C}. One or both of the cathode and anode substantially lack the working ion prior to an initial charge or discharge of the electrochemical cell. At open-circuit prior to an initial charge or discharge, an electric double-layer capacitor is formed at one or both of an interface between the solid glass electrolyte and the anode and an interface between the solid glass electrolyte and the cathode due to a difference between μ_{A} and μ_{C}.

### PRIORITY CLAIM

The present application is a continuation of International Application No. PCT/US2017/041382 filed Jul. 10, 2017; which claims priority to U.S. Provisional Patent Application Ser. No. 62/360,853 filed Jul. 11, 2016. International Application No. PCT/US2017/041382 is also a continuation application of U.S. patent application Ser. No. 15/478,099 filed Apr. 3, 2017, the contents of which are incorporated by reference herein in their entirety.

### TECHNICAL FIELD

The present disclosure relates to self-charging and/or self-cycling electrochemical cells containing a solid glass electrolyte.

### BACKGROUND

An electrochemical cell has two electrodes, the anode and the cathode, separated by an electrolyte. In a traditional electrochemical cell, materials in these electrodes are both electronically and chemically active. The anode is a chemical reductant and the cathode is a chemical oxidant. Both the anode and the cathode are able to gain and lose ions, typically the same ion, which is referred to as the working ion of the battery. The electrolyte is a conductor of the working ion, but normally it is not able to gain and lose ions. The electrolyte is an electronic insulator, it does not allow the movement of electrons within the battery. In a traditional electrochemical cell, both or at least one of the anode and the cathode contain the working ion prior to cycling of the electrochemical cell.

The electrochemical cell operates via a reaction between the two electrodes that has an electronic and an ionic component. The electrolyte conducts the working ion inside the cell and forces electrons also involved in the reaction to pass through an external circuit.

A battery may be a simple electrochemical cell, or it may be a combination of multiple electrochemical cells.

### SUMMARY

The present disclosure provides an electrochemical cell including a solid glass electrolyte including an alkali metal working ion that is conducted by the electrolyte, and a dipole, an anode having an effective anode chemical potential μ_{A}, and a cathode having an effective cathode chemical potential μ_{C}. One or both of the cathode and anode substantially lack the working ion prior to an initial charge or discharge of the electrochemical cell. At open-circuit prior to an initial charge or discharge, an electric double-layer capacitor is formed at one or both of an interface between the solid glass electrolyte and the anode and an interface between the solid glass electrolyte and the cathode due to a difference between μ_{A} and μ_{C}.

The electrochemical cell may have any or all combinations of the following additional features, unless such features are clearly mutually exclusive: a) at least one or both of the cathode and the anode may include a metal; b) at least one or both of the cathode and anode may consist essentially of or consist of a metal; c) both the cathode and the anode may substantially lack the working ion prior to an initial charge or discharge of the electrochemical cell; d) one of the cathode and the anode may include, consists essentially of, or consist of a metal and the other may include a semiconductor; e) one or both of the cathode and the anode may include a catalytic molecular or particle relay that determines its effective chemical potential; f) the working ion may include lithium ion (Li⁺), sodium ion (Na⁺), potassium ion (K⁺) magnesium ion (Mg²⁺), Aluminum (Al³⁺), or any combinations thereof; g) the dipole may have the general formula A_{y}X_{z} or the general formula A_{y-1}X_{z}^{-q}, wherein A is Li, Na, K, Mg, and/or Al, X is S and/or O, 0<z≤3, y is sufficient to ensure charge neutrality of dipoles of the general formula A_{y}X_{z}, or a charge of −q of dipoles of the general formula A_{y-1}X_{z}^{-q}, and 1≤q≤3; h) the dipole may include up to 50 wt % of a dipole additive; i) the dipole additive may include one or a combination of compounds having the general formula A_{y}X_{z} or the general formula A_{y-1}X_{z}^{-q}, wherein A is Li, Na, K, Mg, and/or Al, X is S, O, Si, and/or OH, 0<z≤3, y is sufficient to ensure charge neutrality of dipole additives of the general formula A_{y}X_{z}, or a charge of −q of dipole additives of the general formula A_{y-1}X_{z}^{-q}, and 1≤q≤3; j) the electrochemical cell may have a cycle life of at least a thousand cycles; k) the cell, upon closing of an open-circuit thereof, may exhibit a discharge current without ever having received energy from an external source; l) the electrochemical cell may exhibit a self-cycling component of a charge or discharge current and/or voltage at a fixed control current imposed by an external potentiostat; m) the electrochemical cell may plate the working ion reversibly and dendrite-free on the anode during charge; n) the electrochemical cell may exhibit a self-charge without a control charging current; o) the electrochemical cell may exhibit a self-charge current component with a control charging current component; p) the electrochemical cell may exhibit a self-charge component without a control discharging current; q) the electrochemical cell may exhibit self-charge without a control discharging current; r) the electrochemical cell may have a charge/discharge coulomb efficiency of greater than 100%; s) the electrochemical cell may exhibit a measured charge or discharge current smaller than a control current; t) the electrochemical cell, upon charge, may have a charging current greater than a control current; u) the electrochemical cell may have a measured current in the opposite direction of a control current; v) the electrochemical cell, on discharge, may have a measured discharge current larger than a control current and exhibit self-cycling of both the measured discharge current and the voltage; w) the electrochemical cell may exhibit an alternating current having a period of at least one minute; x) the electrochemical cell may exhibit an alternating current having a period of at least one day.

The present disclosure further includes a battery containing one electrochemical cell as described above, or at least two such cells, which may be in series or in parallel.

Electrochemical cells and batteries disclosed above and elsewhere herein may be rechargeable.

### BRIEF DESCRIPTION OF THE DRAWINGS

For a more complete understanding of the present invention and its features and advantages, reference is now made to the following description, taken in conjunction with the accompanying drawings.

FIG. 1A is a schematic, cross-sectional diagram of an electrochemical cell according to the present disclosure prior to the first charge at open circuit.

FIG. 1B is a schematic, cross-sectional diagram of the electrochemical cell of FIG. 1A during a self-charge.

FIG. 1C is a schematic, cross-sectional diagram of the electrochemical cell of FIG. 1A and FIG. 1B during discharge.

FIG. 2 is a schematic diagram of an equivalent circuit that may be used to calculate the time dependence of the evolution of the measured voltage at open-circuit of the electrochemical cell of FIG. 1A.

FIGS. 3A-3D are a series of graphs of test results for an electrochemical cell having an Al—C anode, a S—C—Cu cathode and a Li+ solid glass electrolyte containing 10% Li₂S. Measured voltage is designated Vme(t). Measured current is designated Ime(t). Control current is designated Icon(t) and is −1 μA versus time (t) after a short charge (vertical line on left in FIG. 3A). FIG. 3A presents results for an electrochemical cell allowed to self-charge without cycling for 41 hours followed by self-cycling for 27 hours with a cycling period of about 8 min. FIG. 3B presents an expanded time-scale graph of the period of the graph of FIG. 3A between 40 and 42 hours. FIG. 3C presents results from a second cycle of the electrochemical cell of FIGS. 3A and 3B after a second short charge while the electrochemical cell is heated, beginning at 20.5 hours from 12° C. to 22° C. over a two-hour period, followed by slow cooling. FIG. 3D presents an expanded time-scale graph of the period of the graph of FIG. 3C during which the electrochemical cell is heated.

FIG. 4 is graph of measured discharge voltage versus time after closing the circuit of an electrochemical cell with a Li anode, a C—Ni mesh cathode, and a Li+ solid glass electrolyte. The cycling period of self-cycling is 24 hours.

FIG. 5A is a graph of test results for an electrochemical cell having an an Al—C anode, a S—C—Cu cathode and a Li⁺ solid glass electrolyte containing 10% Li₂S. Measured voltage is designated Vₘₑ(t). Measured current is designated Iₘₑ(t). Control current is designated I_{con}(t) and is 0.2 mA during charge and −1 μA during self-charge.

FIG. 5B presents an expanded current axis for a portion of the graph of FIG. 5A.

FIG. 6 is a graph of the measured first discharge current versus time after closing the circuit of a jelly roll electrochemical cell with an Al—C anode, a Cu cathode, and a Li⁺ solid glass electrolyte. Discharge was with a low load resistance.

FIG. 7 is a graph of the measured voltage versus time over a 5-hour charge/5-hour discharge cycle for an electrochemical cell with a Li anode, a γMnO₂—C—Li glass-Cu cathode, and a Li⁺ solid glass electrolyte. The electrochemical cell was cycled for 190 days. Peak voltages are indicated by arrows.

### DETAILED DESCRIPTION

The present disclosure relates to an electrochemical cell including a solid glass electrolyte that contains electric dipoles as well as the working ion and that is able to reversibly plate the working ion on either electrode without being resupplied by the other electrode, which causes the electrochemical cell to exhibit a self-charge and a self-cycling behavior. The cell has a solid electrolyte containing, typically, not only mobile alkali metal working cations that can be plated dendrite free on a metallic current collector, but also slower moving molecular electric dipoles. A difference in the electrochemical potentials of the two electrodes is a driving force to create, at open-circuit, an electric-double-layer capacitor at each electrode/electrolyte interface as in a normal electrochemical cell. However, the difference in the translational mobilities of the working cations and of the orientational and translational mobilities of the electric dipoles creates a slower formation of any excess charge in the electrolyte at the interface. The dipole contribution to the interface charge may be large enough to induce plating of the working cation as an alkali-metal layer on the anode, which represents a self-charge. If the counter electrode is unable to resupply the working cation last from the electrolyte via this self-plating or in an applied charging power, the electrolyte becomes charged negatively until an equilibrium between plating and stripping is reached. The charge in the electrolyte is represented in an equivalent circuit as an inductor in parallel with a capacitor, which can create a self-cycling component of a charge or discharge current and/or voltage at a fixed control current imposed by an external potentiostat.

The electrolyte is referred to as glass because it is amorphous, as may be confirmed through X-ray diffraction. The working ion may be an alkali-metal cation, such as Li⁺, Na⁺, K⁺, or a metal cation, such as Mg²⁺, and/or Al³⁺.

Self-charging refers to a phenomenon, as described further herein, in which, an electrochemical cell contains electrodes that, on fabrication, do not contain the working ion of the cell and yet delivers a discharge current on closing the external circuit without ever having received a charging current from an external source. This phenomenon is the result of an alignment and displacement of electric dipoles within the electrolyte after cell assembly as a result of dipole-dipole interactions and an internal electric field. The internal electric field provided by the dipole alignment is large enough to plate the working ion as a metal from the electrolyte on one of the electrodes without resupply to the electrolyte from the other electrode, thereby charging the electrolyte negative. On closing the external circuit, the working ions are returned to the electrolyte and electrons are sent to the external circuit where they provide a discharge current.

Self cycling occurs where the working ion of the electrolyte is plated on an electrode, which charges the electrolyte negative. The negative charge in the electrolyte, when large enough, strips the plated metal back to the electrolyte as cations and releases electrons to the external circuit. The different rates of response of the dipoles and ions in the electrolyte and the electrons to the external circuit result in a cycling of the currents in the external circuit and/or the cell voltage.

Although both self-charging and self-cycling behaviors may occur without an external energy input, both phenomena may also occur as a component of the cell charge/discharge performance with an external charge/discharge input. For example, a self-charging electrochemical cell may be provided with a charging current as an external energy input, in which case it will exhibit a greater charge than is dictated by the charging current to give a coulomb efficiency greater than 100%. As another example, the discharge current and/or voltage may have a self-cycling component of frequency that is different from the charge/discharge cycling frequency.

The solid glass electrolyte of this disclosure is non-flammable and is capable of plating dendrite-free alkali metals on an electrode current collector and/or on itself; the atoms of the plated metal come from the working ion of the electrolyte; the plated working ions may or may not be resupplied to the electrolyte from the other electrode. In particular, the solid electrolyte of this disclosure may be a glass containing as the working ion an alkali-metal cation, such as Li⁺, Na⁺, K⁺, a metal cation, such as Mg²⁺, Al³⁺ as well as electric dipoles such as A₂X or AX⁻, or MgX or Al₂X₃ where A=Li, Na, or K and X═O or S or another element or dipole molecule. Suitable A⁺-glass electrolytes and methods of making them have been previously described in WO2015 128834 (A Solid Electrolyte Glass for Lithium or Sodium Ion Conduction) and in WO2016205064 (Water-Solvated Glass/Amorphous Solid Ionic Conductors), where the alkali-metal-ion disclosures of both are incorporated by references therein.

In general, the metal working ion in the solid glass electrolyte used in the electrochemical cells of this disclosure may be and alkali-metal ion, such as Li⁺, Na⁺, K⁺, or Mg²⁺ or Al³⁺; some of these mobile working ions may also be attached to an anion to form a less mobile electric dipole such as A₂X, AX⁻, or condensates of these into larger ferroelectric molecules in which A=Li, Na, K, Mg, Al and x=O, S, or another anion atom. The glass may also contain as additives up to 50 w % of other electric-dipole molecules than those formed form the precursors used in the glass synthesis without dipole additives. The presence of the electric dipoles gives the glass a high dielectric constant; the dipoles are also active in promoting the self-charge and self-cycling phenomenon. In addition, the solid glass electrolytes are not reduced on contact with metallic lithium, sodium, or potassium and they are not oxidized on contact with high-voltage cathodes such as the spinel Li[Ni_{0.5}Mn_{1.5}]O₄ or the olivines LiCo(PO₄) and LiNi(PO₄). Therefore, there is no formation of a passivating solid-electrolyte interphase (SEI). Also, the surfaces of the solid-glass electrolytes are wet by an alkali metal, which allows plating from the glass electrolyte dendrite-free alkali metals that provide a low resistance to transfer of ions across an electrode/electrolyte interface over at least a thousand, at least two thousand, or at least five thousand charge/discharge cycles.

The solid glass electrolyte may be applied as a slurry over a large surface area; the slurry may also be incorporated into paper or other flexible cellulose or polymer membranes; on drying, the slurry forms a glass. The membrane framework may have attached electric dipoles or, on contact with the glass, forms electric dipoles that have only rotational mobility. The electric dipoles within the glass may have translational as well as rotational mobility at 25° C. Reactions between the dipoles with translational mobility may form dipole-rich regions within the glass electrolyte with some dipole condensation into ferroelectric molecules; the coalescence of the dipoles, which is referred to as aging of the electrolyte, may take days at 25° C., but can be accomplished in minutes at 100° C.

One or more of the dipoles may have some mobility even at 25° C. An electrode consists of a current collector and/or a material having an active redox reaction. An electrode current collector is a good metal such as Al or Cu; it may also be a form of carbon, an alloy, or a compound such as TiN or a transition-metal oxide. The current collector may be an electrode without an active material on it or it may transport electrons to/from an active material on it; the active material may be an alkali metal, an alloy of the alkali metal, or a compound containing an atom of the working ion of the electrolyte. The current collector transports electrons to or from the external circuit and to or from my active material of an electrode reacts with the working ion of the electrolyte by having electronic contact with the current collector and ionic contact with the electrolyte. The ionic contact with the electrolyte may involve only excess or deficient working-ion concentration at the electrode/electrolyte interface, which creates an electric-double-layer capacitor (EDLC), or it may also involve formation of a chemical phase at the electrode surface. In a rechargeable cell, any chemical formation on an electrode surface as well as the EDLC across the electrode/electrolyte interface is reversible.

According to the present invention, one or both electrodes in the electrochemical cell are, on fabrication, only current collectors containing no detectable atom of the working ion of the electrolyte down to 7000 ppm by, for example, atomic absorption spectroscopy. However, after cell assembly, atoms of the working ion of the electrolyte may be detected on the electrode by atomic absorption spectroscopy or by other means.

In addition, one or both electrodes of the cell may contain an additional electronically conductive material such as carbon that aids plating of the working cation on the current collector without changing significantly the effective Fermi level of the composite current collector.

The solid glass electrolyte may have a large dielectric constant, such as a relative permittivity (σ_{R}) of 10² or higher. Solid glass electrolytes are non-flammable and may have an ionic conductivity σ_{A} for the working ion A⁺, of at least 10⁻² S/cm at 25° C. This conductivity is comparable to the ionic conductivity of the flammable conventional organic-liquid electrolytes used in Li-ion batteries, which makes the cells safe.

The solid glass electrolyte may be formed by transforming a crystalline electronic insulator containing the working ion or its constituent precursors (typically containing the working ion bonded to O, OH, and/or a halide) into a working-ion-conducting glass/amorphous solid. This process can take place in the presence of dipole additives as well. The working ion-containing crystalline, electronic insulator or its constituent precursors may be a material with the general formula A₃₋ₓHₓOX, wherein 0≤x≤1, A is at least one alkali metal, and X is the at least one halide. Water may exit the solid glass electrolyte during its formation.

An electrochemical cell containing a solid glass electrolyte as disclosed herein may have a large energy gap E_{g}, in which E_{g}=Eₑ−Eᵥ. E_{c} is the bottom of the conduction band and E_{c}>μ_{A}, where μ_{A} is the anode chemical potential. Eᵥ is the top of the valence band and Eᵥ<μ_{C}, where c is the cathode chemical potential. The energy difference μ_{A}−μ_{C} may drive the self-charging and self-cycling behaviors. In addition, the dipoles contribution causes the electrochemical cell to have a capacitance at open or closed circuit that is higher than in an otherwise identical electrochemical cell with an electrolyte other than a solid glass electrolyte as disclosed herein.

An electrochemical cell containing the solid glass electrolyte as disclosed herein may also be able to plate and strip the working ion from one or both electrodes such that an electrolyte-electrode bond between the electrolyte and at least one electrode is sufficiently strong for electrolyte volume changes during cycling to be substantially perpendicular to the interface between the electrolyte and the electrode. Typically the bond will be sufficiently strong between the electrolyte and both electrodes for the electrolyte volume changes to be substantially perpendicular to both interfaces between the electrolyte and both electrodes.

In what follows, a control current I_{con} is the current specified by the potential difference between the two electrodes controlled by a load in a potentiostat, whereas the measured current I_{mc} is the actual measured current, which includes the current specified by the potentiostat and the current resulting from the self-charge. The current resulting from the self-charge may be in the same or the opposite direction of I_{con} on discharge. The subscript dis and ch are added to specify whether we refer to discharge or charge currents and voltages.

An electrochemical cell as disclosed herein may have a measured discharge current I_{me-dis} and/or a measured charging current I_{me-ch} less than the control current I_{con}.

During charge, an electrochemical cell as disclosed herein may have a charging current I_{ch} that is greater than the control current I_{con}. During discharge, an electrochemical cell as disclosed herein may have a measured discharge current I_{me-dis} that is larger than the discharge control current I_{ds-con}. Such an electrochemical cell, in addition to normal discharge, may exhibits self-cycling of both the measured discharge current I_{me-dis} and voltage V_{me-dis}

An electrochemical cell as disclosed herein may, at open-circuit, develop a voltage that is less than or equal to the theoretical voltage as a result of the difference in the electrode electrochemical potentials.

An electrochemical cell as disclosed herein may have a self-voltage sufficiently large to cause a working ion in the electrolyte to plate onto the anode at open-circuit. Moreover, the electric power delivered by the self-charge may be sufficient to light a red LED for over a year.

An electrochemical cell as disclosed herein may exhibit plating of the ion on either electrode current collector when subjected to a constant I_{con} or V_{con}. Plating of the working cation from the electrolyte without being resupplied by the counter electrode may result in a self-cycling component of the measured current Iₘₑ and measured voltage Vₘₑ.

In what follows, a control current I, is the current specified by the potential difference between the two electrodes controlled by a load in a potentiostat, whereas the measured current Iₘₑ is the actual measured current, which includes the current specified by the potentiostat and the current resulting from the self-charge. The current resulting from the self-charge may be in the same or the opposite direction of I_{con} on discharge. The subscripts dis and ch are added to specify whether we refer to discharge or charge currents and voltages.

An electrochemical cell as disclosed herein may exhibit self-cycling at a given cycle period. Due to self-charging, the period of the self-cycling is independent of charge/discharge period.

The measured current Iₘₑ of an electrochemical cell as described herein contains both direct current and alternating current components. In some applications, only the alternating-current portion may be used, for example in signaling. The alternating current period is the self-cycling period which may have a period of between minutes and days.

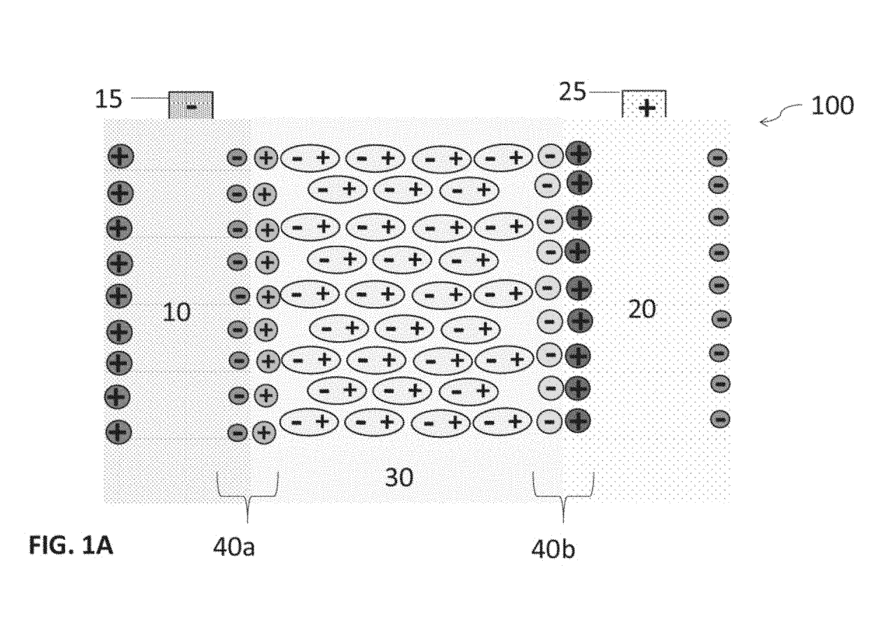

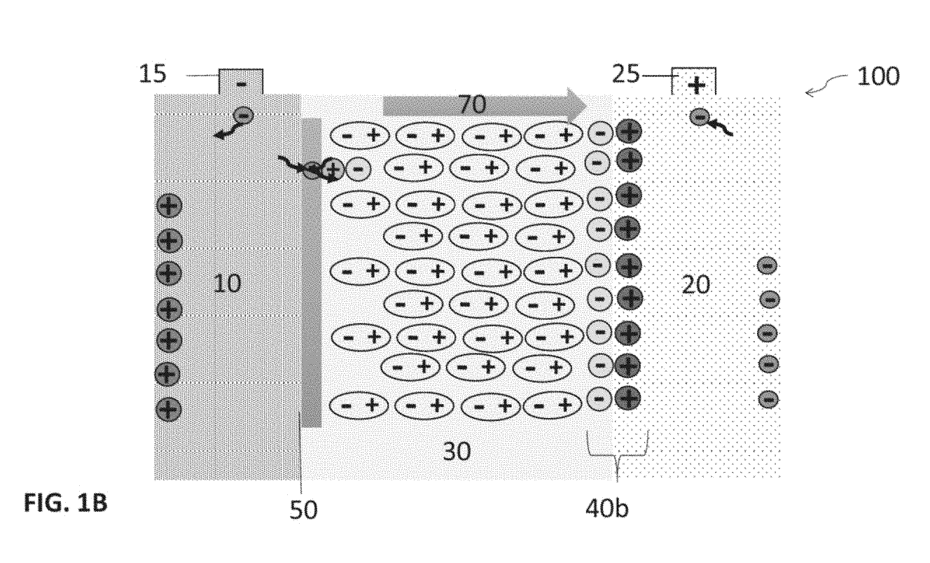

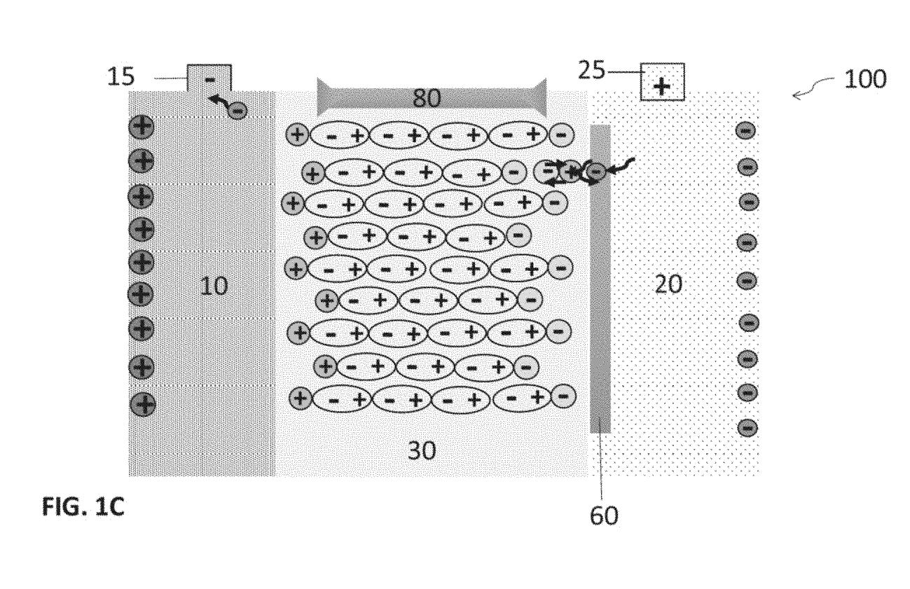

The principles by which an electrochemical cell as disclosed herein may operate are better understood through reference to FIG. 1, which includes FIG. 1A to illustrate the electrochemical cell 100 prior to cycling, FIG. 1B to illustrate the electrochemical cell 100 during self-charge, and FIG. 1C to illustrate the electrochemical cell 100 during discharge.

In FIG. 1A, FIG. 1B, and FIG. 1C, electrochemical cell 100 contains anode 10 with contact 15, cathode 20 with contact 25, and solid alkali-metal-ion glass electrolyte 30. Excess working ions in electrolyte 30 are represented by + circles. Depletion of working ions in electrolyte 30 are represented by − circles. Electric dipoles in electrolyte 30 are represented by +/− ellipses. Electronic charges in the electrodes are represented by + and − circles. In FIG. 1B and FIG. 1C, arrows attached to circles represent directions of motion of the charges associated excess mobile cations or deficiency of mobile cations in the electrolyte, electrons in the electrode.

FIG. 1A illustrates schematically electrochemical cell 100 at open-circuit. The chemical potential (μ_{A}) of anode 10 is higher than the chemical potential (μ_{C}) of cathode 20. To balance the energy between the anode and the cathode chemical potentials, electric double-layer capacitors 40a and 40b are formed at the interfaces between the electrodes and the electrolyte. Energy for the formation of these electric double-layer capacitors 40a and 40b is supplied by the differences in chemical potentials of anode 10 and cathode 20.

One such electrochemical cell 100 may have an alkali metal anode 10 and a Cu cathode 20, with an alkali-metal working ion (A⁺) in the solid glass electrolyte 30.

Displacement of the working ion (A⁺) and the electric dipoles in solid glass electrolyte 30 allows the formation of electric double-layer capacitors 40a and 40b. As illustrated in FIG. 1A, at open-circuit, electric double-layer capacitor 40a at the interface of anode 10 (which is the negative terminal of electrochemical cell 100) and electrolyte 30 has an excess of working ions in electrolyte 30 (represented as +), which results from the shift of those working ions in electrolyte 30 towards its anode side. The portion of anode 10 at the interface will have an excess of negative electronic charge, (represented as −), with a compensatory excess of positive cation charge on the electrolyte side of the interface between anode (1) and electrolyte 30 that are separated from one another.

Electric double-layer capacitor 40b at the interface of cathode 20 (which is the positive terminal of electrochemical cell 100) and electrolyte 30 has a depletion of working cations in electrolyte 30 (represented as −), which results from the shift of working ions in the electrolyte 30 towards its anode side and away from its cathode side. The portion of cathode 20 at the interface will have a compensatory excess of positive electronic charge (represented as +), in cathode 20 distant from the interface with electrolyte 30.

Other than at the interfaces with the electrodes where charge varies as described above, electrolyte 30 will have a neutral net charge.

The shifting of the working ion in electrolyte 30 and the resulting formation of electric double-layer capacitors 40a and 40b occurs fairly rapidly once electrochemical cell 100 is assembled.

Due to the shift in working ions in electrolyte 30 and the resulting electric field in a direction to equilibrate the difference in the electrochemical potentials of the two electrodes, electric dipoles in the solid glass electrolyte will tend to orient themselves with their negative ends towards the interface between electrolyte 30 and anode 10 and with their positive ends towards the interface between electrolyte 30 and cathode 20, as illustrated by the + and − indicators in FIG. 1A.

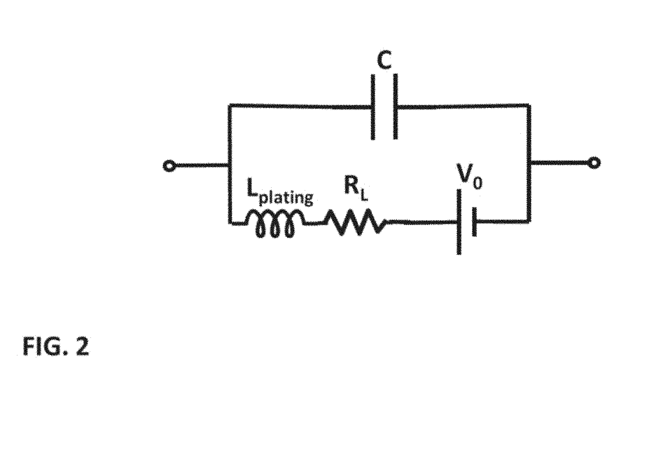

This alignment of the electric dipoles and their translational motion does not occur instantaneously and is a considerably slower process than formation of the electric double-layer capacitors 40a and 40b. As a result, the open circuit voltage as measured over time (Voc(t)) evolves as alignment and dipole translations occur. This evolution of Voc(t) may be modeled using an equivalent circuit, as shown in the schematic diagram of FIG. 2. The schematic diagram of FIG. 1A represents a hypothetical electrochemical cell 100 in which the dipoles a in solid glass electrolyte 30 are all aligned and displaced. In reality, complete alignment and displacement are not likely to be achieved and dipole translations and alignment will increase as Voc(t) evolves. Increased dipole alignment also strengthens the electric field across electrolyte 30 and drives further dipole alignment and movement. Maximum alignment and motion in a given electrochemical cell 100 may be assumed to have occurred when V_{oc} ceases to change in a consistent direction over time, or during a given period of time, such as for at least one minute or at least five minutes for alignment and days or minutes for movement depending on the temperature.

In some instances, the additional electric field created by dipole alignment and motion in electrolyte 30 may be sufficient to even drive plating of the working ion on anode 10 when electrochemical cell 100 is at open-circuit. Eventually, the net negative charge that electrolyte 30 develops as a result of this plating process will be sufficiently high that it cannot be overcome by the electric field and plating on anode 10 will cease.

FIG. 1B illustrates electrochemical cell 100 when its circuit is first closed, for example by connecting an external circuit to contacts 15 and 25. The external circuit includes a potentiostat that imposes a charging control current I_{con} that may be less than some critical current I. The critical current is the maximum I_{con-dis} at which self-charge phenomenon still exist as shown in FIG. 1B. When the circuit is closed, the energy stored in electric double-layer capacitors 40a and 40b and by the aligned dipoles in electrolyte 30 introduces a charging current I_{ch}. This phenomena self-charges electrochemical cell 100.

During self-charge, while the discharging control current I_{con} is being applied, some electrons are transported from cathode 20 to anode 10 where they reduce excess working ions in electrolyte 30 near the interface with anode 10 reduced, to plate then on anode 10 forming plated metal 50.

Cathode 20 lacks the working ion, so it cannot resupply working ions as they are depleted from electrolyte 30 to form plated metal 50. Accordingly, the electrolyte 30 at the interface with anode 10 becomes increasingly negatively charged, eventually reaching the point where the working ion is no longer being plated on anode 10 as plated metal 50 and the working ions begin to be stripped back to the electrolytes.

Alternatively, the plated metal may become so thick that the electrode chemical potential becomes that of the plated metal so rather than that of the current collector, 10, which makes it more difficult to plate the working cation from the electrolyte as the metal 50, thereby terminating the plating process. In either case, as plating of the working ion to anode 10 decreases, the measured charging current I_{me-ch}, decreases.

In addition the initial electrons removed from the cathode by the charging current I_{ch} retains electric double-layer capacitor 40b, resulting in a shift of the dipoles in direction 70, towards cathode 20. Working ions in electrolyte 30, however, do not shift towards cathode 20.

Eventually the depletion of the working ion from electrolyte 30 near anode 10 induces its stripping from plated metal 50 back to the electrolyte 30 in a discharge phase, I_{me-ch} further decreases and the electric double-layer capacitors 40a and 40b are restored (not shown). Eventually the energy stored in the electric double-layer capacitors is sufficiently high that further stripping of the working ion from plated metal 50 cannot contribute sufficient additional energy to still occur, and plating of the working ion on anode 10 as plated metal 50 resumes, causing an increase in I_{me-ch}.

Although the above description presents plating and stripping in a simplified manner, with one happening at any time, in the actual electrochemical cell 100, typically both plating and stripping occur at the same time during at least part of each cycle, but one process predominates so that there is net plating or net stripping.

This alteration between net plating and net stripping of the working ion from plated metal 50 on anode 10 results in self-cycling of electrochemical cell 100, with concurrent cycling of the voltage (V). This self-cycling occurs with a given cycle period, that tends to remain constant as long as cycling continues. The cycle period depends on the difference in the rates of electronic versus cation and dipole translational motion.

In an electrochemical cell 100 such as that of FIG. 1B, where I_{con} is less than I_{c}, the cycle period may be on the order of minutes, between one and ten minutes.

FIG. 1C illustrates electrochemical cell 100 during discharge through an external circuit that includes a potentiostat that imposes a control current I_{con} that is greater than the critical current I_{c}, as in a low-load external circuit, such as might include a light-emitting diode (LED). As in the electrochemical cell of FIG. 1B, once the circuit is closed, energy is stored in electric double-layer capacitors 40a and 40b and by the aligned dipoles in electrolyte 30.

During discharge, a current I_{dis} is created and may be controlled by I_{con}. The load of the external circuit is sufficiently low for electrons to flow from anode 10 to cathode 20 to attract working ions from electrolyte 30 to cathode 20, where they combine with the electrons and form plated metal 60 on cathode 20. The transfer of electrons from anode 10 to cathode 20 reduces both electric double-layer capacitors 40a and 40b, but it primarily reduces electric double-layer capacitor 40b, at the electrolyte-cathode interface. This lowers the electric field across electrolyte 30, allowing the working ion to be plated on cathode 20. Although electric double-layer capacitor 40b is depleted, it is typically not destroyed so long as the majority of the dipoles in electrolyte 30 remain oriented in the same way as when electrochemical cell 100 is at open circuit. The dipoles in electrolyte 30 are, however, compressed in direction 80.

Anode 10 substantially lacks the working ion, so it cannot resupply working ions as they are depleted from electrolyte 30 to form plated metal 60. In addition, changes in the internal electric field of electrolyte 30 that are created by electron transfer that occurs much faster than the working ion and electric dipoles can redistribute and align to accommodate them. Accordingly, the electrolyte 30 at the interface with cathode 20 becomes increasingly negatively charged, eventually reaching the point where the working ion is also stripped from plated metal 60 and returned to electrolyte 30, resulting in a measured discharge current Iₘₑ that is increasingly lower until it reaches Iₘₑ minimum until plating and stripping are in equilibrium.

Alternatively, in some electrochemical cells 100, plated metal 60 may eventually become so thick, electrolyte 30 is effectively screened from cathode 20 and working ions in electrolyte 30 are substantially all exposed to plated metal 60 which does not have a sufficient difference in chemical potential as compared to anode 10 to cause additional plating based on the difference in chemical potential alone or combined with any remaining electric field in electrolyte 30. In such cases, the working ion may no longer be plated to cathode 20 as plated metal 60.

Iₘₑ increases as the working ion is plated metal 60. When Iₘₑ reaches maximum, the process reverses and working ions are once again plated on cathode 20 as metal plate 60.

This alteration between plating and stripping of the working ion from plated on metal 60 on cathode 20 results in self-cycling of electrochemical cell 100, with concurrent cycling of the voltage and Iₘₑ. This self-cycling occurs with a given cycle period that tends to remain constant as long as cycling continues. The cycle period depends on the rate of compression in direction 80 of the dipoles in electrolyte 30 during discharge and their expansion during charge. Typically increasing Iₘₑ towards maximum is faster than decreasing it to minimum.

In an electrochemical cell 100 such as that of FIG. 1C, where I_{con} is greater than I_{c}, the period may be on the order of days, such as one and seven days.

Electrons can only pass one way through an LED. Accordingly, in actual use of electrochemical cell 100, anode 10 is increasingly positively charged and cathode 20 is increasingly negatively charged until the electric field across electrolyte 30 reverses the orientation of the electric dipoles, which then switches off the current that flows through the load. For electrochemical cells with a small Iₘₑ, the time required for this to occur may be lengthy, even more that a year. Thus, an electrical device may be powered by electrochemical cell 100 for that length of time with no external energy input.

In an electrochemical cell 100 in which both electrodes substantially lack the working ion prior to cell assembly, an external charging current I_{ch} may create large electric double layer capacitors 40a and 40b, which may cause the working ion to plate from electrolyte 30 onto anode 10, as such plating occurs during charging of a conventional rechargeable electrochemical cell. However, depletion of the working ion from the electrolyte 30 with no resupply from cathode 20, in contrast to a conventional rechargeable electrochemical cell in which such resupply does occur, causes increasing resistance to further plating on anode 10 as negative charge in electrolyte 30 near anode 10 increases. In addition, changes in the electric field across electrolyte 30 by molecular and atomic accommodations in the electrolyte that are slower than the electronic motions in the current collectors change the rates of self-charge and self-cycling. Accordingly, as in the case of the electrochemical cell of FIG. 1B above, stripping of working ions from anode 10 also occurs. Eventually, at a constant control external charging current I_{con-ch}, an equilibrium is reached between plating and stripping of the working ion at anode 10.

In such an electrochemical cell, the measured charging current I_{me-ch} is larger than the constant control external charging current I_{con-ch} because the electric double-layer capacitors 40a and 40b are charged in addition to the working ion being plated and stripped. In addition, the magnitude of the measured charging voltage V_{me-ch} and the measured charging current I_{me-ch} change cyclically over time as plating and stripping alternate.

In such a cell, average I_{me-ch} may be greater than or equal to I_{con-ch} while the working ion is being stripped from and plated to anode 10. As the plating/and stripping at anode 10 continues, the electric double-layer capacitor 40a near anode 10 is also being charged. Eventually, electric double-layer capacitor 40a is charged sufficiently for the negative charge on the anode side to block the return of electrons to anode 10, thereby preventing further stripping of the working ion from anode 10. At this point, continued charging can only charge the electric double-layer capacitor 40a. As a result, self-cycling of the voltage stops and the voltage increases linearly with time at a rate that depends on I_{con-ch}.

In a variation, if the working ion has been plated on cathode 20 before the external charging current is applied, then the measured discharge current I_{me-dis} self-cycles until the working ion has been substantially stripped from cathode 20. The measured discharge voltage Vₘₑ, however, does not cycle.

In FIG. 2, an inductance is introduced into the equivalent circuit to represent the role of the negative charge introduced into electrolyte 30 by plating of the working cation from the electrolyte without a resupply to the electrolyte from a counter-cation. In FIG. 2, C represents the capacitance of the association in series of 40a and 40b EDLCs, R_{L} the plating resistance, and

$${V}_{0} = \frac{{μ}_{A} - {μ}_{C}}{e}$$

the driving force.

Electrochemical cells of the present disclosure may be used in batteries. Such batteries may be simple batteries containing few components other than an electrochemical cell and a casing or other features. Such batteries may be in standard battery formats, such as coin cell, standard jelly roll, pouch, or prismatic cell formats. They may also be in more tailored formats, such as tailored prismatic cells.

Electrochemical cells of the present disclosure may also be used in more complex batteries, such as batteries containing complex circuitry and a processor and memory computer-implemented monitoring and regulation.

Regardless of simplicity, complexity, or format, all batteries using electrochemical cells of the present disclosure may exhibit improved safety, particularly a lower tendency to catch fire when damaged, as compared to batteries with organic-liquid electrolytes.

A battery may contain a single electrochemical cell as disclosed herein, or two or more such cells, which may be connected in series or in parallel.

Electrochemical cells as disclosed herein and batteries containing them may be rechargeable.

Electrochemical cells of the present disclosure may also be used in devices that take advantage of the electric double-layer capacitor, such as in capacitors. They may also be used in devices that take advantage of the cycle period, particularly the AC period, such as signaling devices.

By way of example, electrochemical cells of the present disclosure may be used as a dielectric gate of a field-effect transistor; in portable, hand-held and/or wearable electronic device, such as a phone, watch, or laptop computer; in a stationary electronic device, such as a desktop or mainframe computer; in an electric tool, such as a power drill; in an electric or hybrid air, land or water vehicle, such as a boat, submarine, bus, train, truck, car, motorcycle, moped, powered bicycle, aircraft, drone, other flying vehicle, and toy versions thereof; for other toys; for energy storage, such as in storing electricity from wind, solar, hydropower, wave, or nuclear energy and/or in grid storage or as a stationary power store for small-scale use, such as for a home, business, or hospital; for a sensor, such as a portable medical or environmental sensor; to generate a low frequency electromagnetic wave, such as for underwater communication; as a capacitor, such as in a supercapacitor or a coaxial cable; or as a transducer.

### EXAMPLES

The following examples are provided to further illustrate the principles and specific aspects of the invention. They are not intended to and should not be interpreted to encompass the entire breath of all aspects of the invention.

### Example 1—I_{con}<I_{c} in an Electrochemical Cell

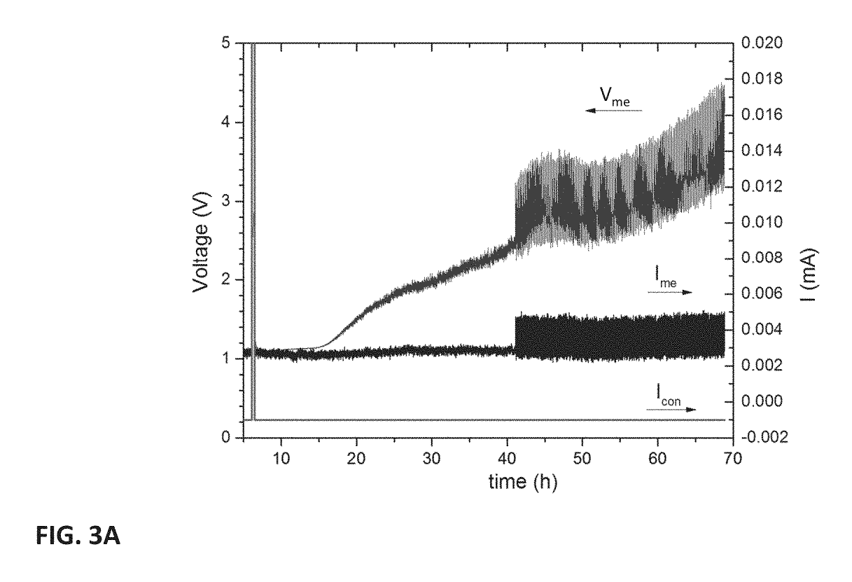

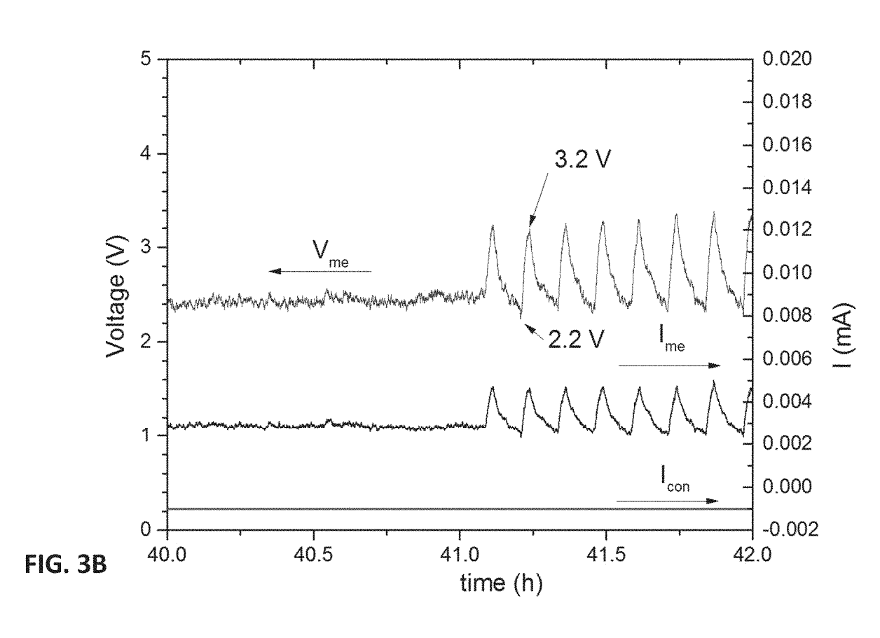

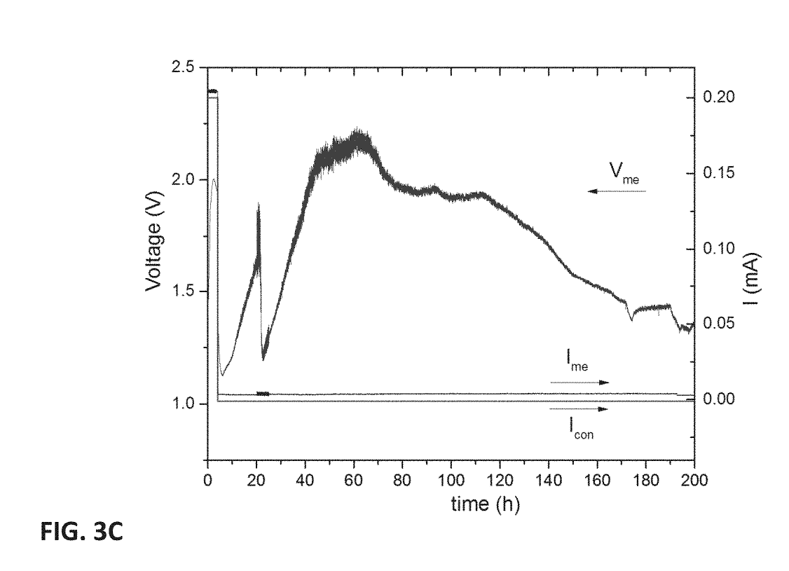

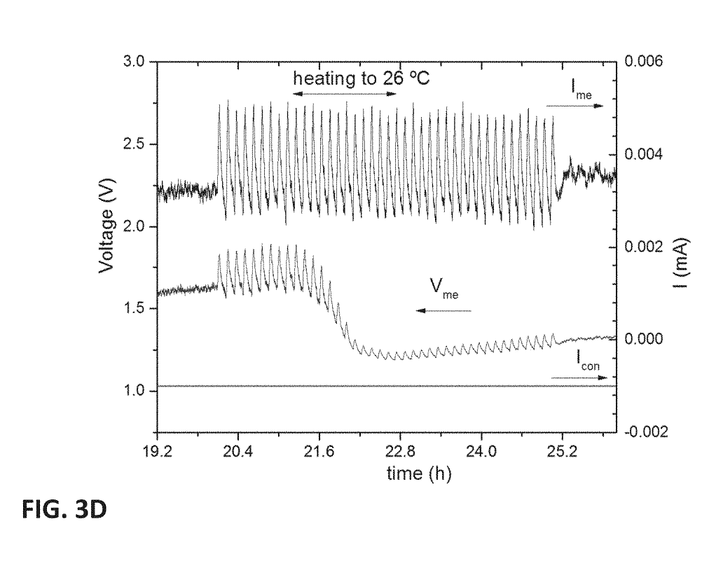

FIG. 3 presents results of an experiment demonstrating self-charge and self-cycling of an electrochemical cell with an Al—C anode, a S—C—Cu cathode and a Li⁺ solid glass electrolyte containing 10 wt % Li₂S (an Al—C/Li+-glass/S—C—Cu cell).

The Al anode had a carbon layer (Al—C) contacting the Li-glass electrolyte. The cathode was a Cu current collector with a carbon layer containing a sulfur relay contacting the Li-glass electrolyte.

In FIG. 3A, the measured voltage of the electrochemical cell versus time showed, after 6 h 26 min, a charge of 0.5 mA for 25 min that was followed by an abrupt discharge of the electric double-layer capacitors. The voltage at a constant I_{con} increased little for the next 8 h 22 min as the electric double-layer capacitors were recharged, before increasing to 2.4 V with small-amplitude noise over the next 35 h 29 min. The measured voltage, Vₘₑ of 2.4 V was the maximum voltage for self-charge plating of lithium metal Li⁰ on the anode. A brief break in the rate of voltage increase occurred when Vₘₑ is 2.2 V before oscillations begin. The theoretical Vₘₑ for (μ_{A}−μ_{C})/e was 2.2 V. Once the thickness of the plated Li⁰ on the Al—C anode reached a critical thickness, plating/stripping of Li⁰ oscillated between plating at μ_{A}(Li)−μ_{C}(Cu) and μ_{A}(Al)−μ_{C}(Cu).

FIG. 3B shows an enlarged image of the onset of self-cycling between [μ_{A}(Li)−μ_{C}(Cu)]/e and [μ_{A}(Al)−μ_{C}(Cu)]/e in the measurement of FIG. 3A, allowing the oscillations to be more clearly seen.

FIG. 3C shows the Vₘₑ of the cell of FIG. 3A in a second cycle at a constant I_{con} after an initial charge of Co₂ mA for 25 min. During self-charge, Li⁺ from the glass electrolyte was plated on the Al anode after charging of the electric double-layer capacitors, and the Li⁺ working ions were not resupplied to the electrolyte from the Cu cathode. On reaching Vₘₑ of 1.65 V, as further visible in enlarged FIG. 3D, a self-cycling with an average Vₘₑ of approximately 1.7 V began.

A sharp drop in Vₘₑ occurred when the temperature of the electrochemical cell was increased by heating from 12° C. to 26° C. The electrochemical cell was then removed from the heater and allowed to return slowly to 120. During cooling, Vₘₑ increased to 2.1 V, the difference between the chemical potentials of Al and Cu. At that voltage, the electrochemical cell began to plate the working ion again, but without periodic cycling, until a small discharge occurred, followed by longer period cycling; a discharge of the electric double-layer capacitor to a Vₘₑ of approximately 1.4 V occurred. At that point, plating resumed. Throughout these voltage changes, the measured charging current Iₘₑ remained nearly constant, with only a small decrease during the final plating that was terminated abruptly at the final recorded discharge. The changes with temperature reflect the ionic and molecular motions in the electrolyte.

### Example 2—I_{con}>I_{c} in a LED-Containing External Circuit

Electrochemical cells with an electrochemical cell with an Al anode, a Cu cathode and a Li+ solid glass electrolyte (Al/Li⁺-glass/Cu cells) were constructed and then connected in series to light a red LED in an external circuit. These cells exhibited self-charging with a discharge current, I_{dis} that is greater than a critical current I_{c}. The electrochemical cells had been previously cycled, but were not charged or otherwise supplied with an external energy input. The cells have powered the LED for approximately two years. Data per cell for the first year is presented in Table 1. The total density of energy delivered over the first year was 373.8 Wh/g.

TABLE 1
Al/Li⁺-glass/Cu Cells Over One Year
with an LED-Containing External Circuit

| | |
|---|---|
| Days | 365 |
| I(A) = I_{mes-dis} > I_{C} | 1.6 × 10⁻⁴ |
| Capacity, Q(Coulombs) | 5046 |
| Voltage (V) average cell | 0.53 |
| Energy (J or Ws) per cell | 2691 |
| Energy (Wh) per cell | 0.748 |
| Mass per cell (kg) | 2 × 10⁻³ |
| Energy (Wh/kg) per cell | 373.8 |

### Example 3—I_{con}>I_{c} in an Electrochemical Cell with a Li Anode

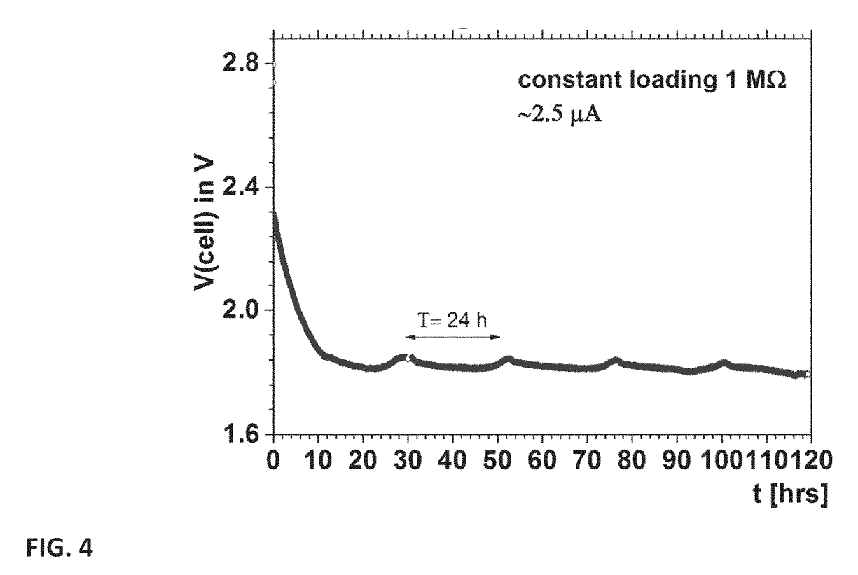

FIG. 4 presents the measured voltage Vₘₑ(t) of a discharging electrochemical cell with a Li metal anode, a Li⁺ glass electrolyte and a C—Ni cathode, with carbon located in a Ni mesh (Li-metal/Li+-glass/C—Ni cell). The load resistance was 1 mega ohm and the discharge current of approximately 2.5 μA. The periodic hillocks in the voltage were the result of a periodic self-cycling of a self-charge component in the cell discharge compound. Plating on the cathode had a longer period than plating on the anode (as shown in FIG. 3B). Due to the excess energy supplied by self-charging, the electrochemical cell exhibited a charge/discharge coulomb efficiency greater than 100% on cycling.

### Example 4—Constant Applied Charging Current (I_{con-ch})>I_{c}

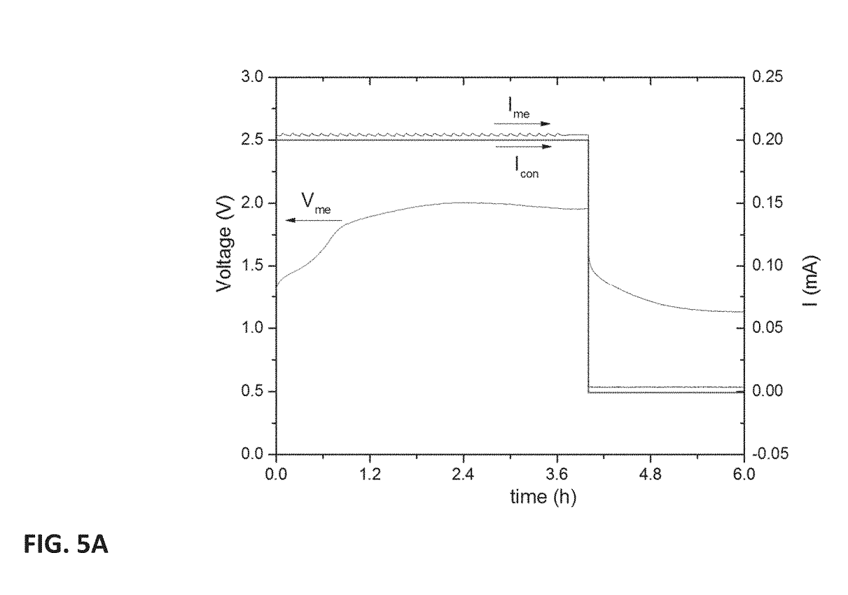

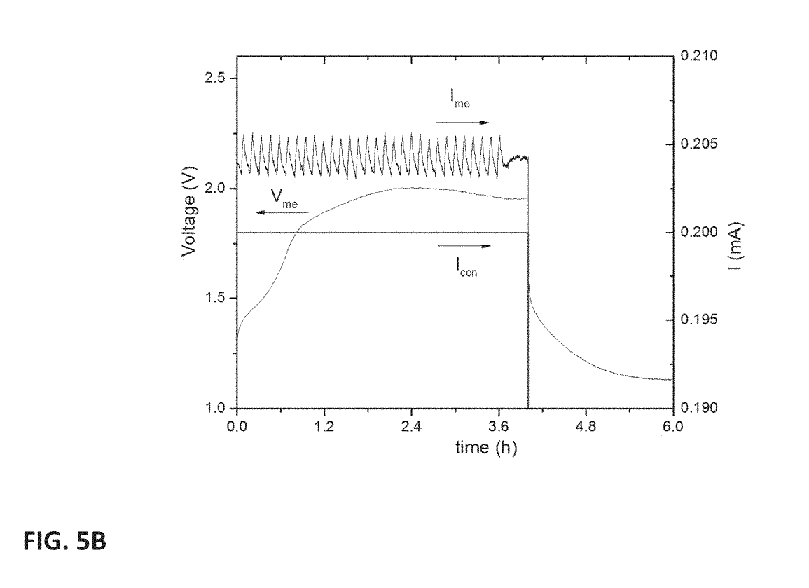

FIG. 5A presents data showing self-cycling of a measured charging current I_{me-ch} with a constant charging control current I_{con-ch} in an Al—C/Li⁺-glass/S—C—Cu cell such as that used in Example 1 on a second charge/discharge cycle. The cells were recharged by an external power source after the first discharge. The measured voltage (Vₘₑ) was 2.1 V, corresponding to [μ_{A}(Al)−μ_{C}(Cu)]/e. I_{me-ch}, which was greater than I_{con}, exhibited self-cycling with an amplitude such that I_{me-ch} remained greater than I_{con}, as seen in FIG. 5B.

I_{me-ch} remained greater than I_{con-ch}, indicating that stripping of lithium metal from the cathode contributed to I_{me-ch}, with plating/stripping cycling that must result from an electrolyte charge localized near the interface of the electrolyte and the cathode because any possible resupply of Li⁺ from the anode would take longer than the short self-cycling period. The average I_{me-ch} remained constant until most, if not all of the lithium metal was stripped from the cathode and charging of the cathode electric double-layer capacitor commenced. There was no corresponding cycling of Vₘₑ because the cycling phenomena was localized to the cathode/electrolyte interface.

### Example 5—I_{dis}>I_{c} in a Jelly-Roll Electrochemical Cell

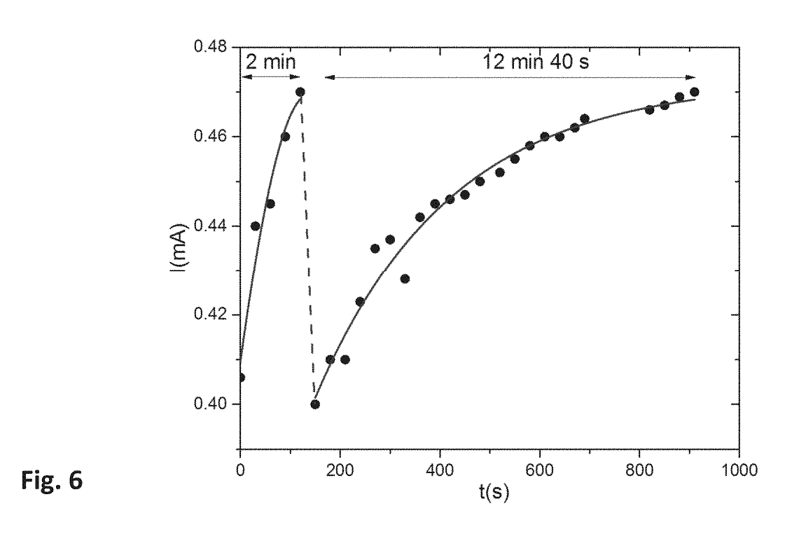

FIG. 6 presents the measured discharge current Iₘₑ of a jelly-roll Al—C/Li⁺ glass/Cu cell, otherwise similar to that of Example 2, with a small load resistance R_{L} of 0.1Ω. At open-circuit, the cathode electric double-layer capacitor depleted Li⁺ in the electrolyte at its interface with the cathode. When the circuit was closed, electrons from the anode imparted a negative charge to the Cu cathode, which attracted Li⁺ back to the cathode interface. However, ion movement is slower than electron movement, so Iₘₑ increased at the rate of Li⁺ movement back to the cathode/electrolyte interface. At a critical electrolyte/cathode electric double-layer capacitor voltage, the Li⁺ from the electrolyte were plated on the cathode as lithium metal and Iₘₑ abruptly dropped. Subsequent rebuilding of the cathode/electrolyte electric double-layer capacitor took more time, as the negative electrolyte charge impeded Li⁺ migration to the cathode/electrolyte interface, where plating once again occurred.

### Example 6—Charge/Discharge Cycling of an all-Solid-State Lithium Electrochemical Cell

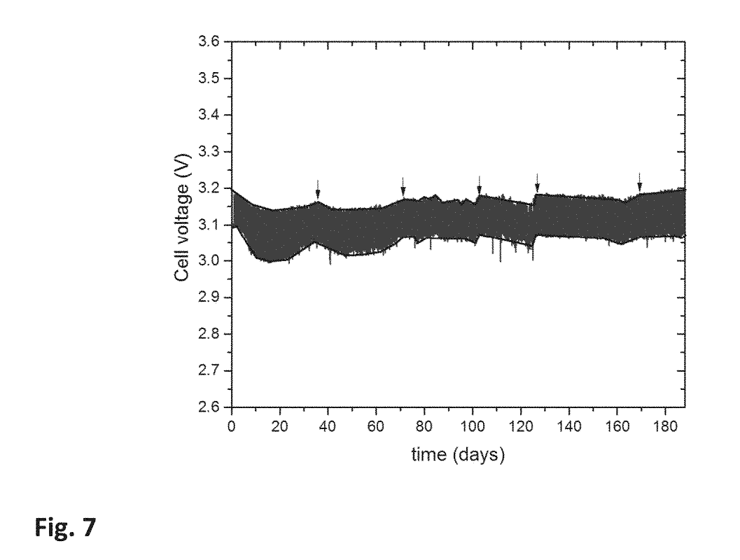

FIG. 7 shows the variation with time of the charge and discharge voltage on cycling an electrochemical cell with a Li anode, a Li⁺ glass electrolyte, and a MnO₂—C—Li-glass-Cu cathode with a γMnO₂ catalytic relay in a carbon layer contacting a Cu current collector (a Li/Li⁺-glass/MnO₂—C—Cu cell). Each cycle was 10 h 30 min for 444 cycles at a control current I_{con} of 70 μA and a measured discharge current Iₘₑ of 53 μA.

Iₘₑ being less than I_{con} indicates the presence of a self-charge current that opposed the discharge I_{con}. The profile of Vₘₑ showed cycling typical of self-charge via plating on the anode in excess of the Li⁺ resupplied to the electrolyte via stripping from the cathode. The discharge voltage profile also showed a long cycle period of 34 days.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1. A method of operating an electrochemical cell, the method comprising discharging an electrochemical cell prior to the electrochemical cell having received energy from an external source, the electrochemical cell comprising:
a solid glass electrolyte comprising:
an alkali metal working ion that is conducted by the electrolyte; and
a dipole;
an anode; and
a cathode,
wherein one or both of the cathode and anode substantially lack the working ion prior to discharging the electrochemical cell.

2. The method of claim 1, wherein both the cathode and the anode substantially lack the working ion prior to the initial charge or discharge of the electrochemical cell.

3. The method of claim 1, wherein the working ion is lithium ion (Li⁺), sodium ion (Na⁺), or potassium ion (K⁺), or any combinations thereof.

4. The method of claim 1, wherein the dipole has the general formula A_{y}X_{z} or the general formula A_{y-1}X_{z}^{-q}, wherein A is Li, Na, K, Mg, and/or Al, X is S and/or O, 0<z≤3, y is sufficient to ensure charge neutrality of dipoles of the general formula A_{y}X_{z}, or a charge of −q of dipoles of the general formula A_{y-1}X_{z}^{-q}, and 1≤q≤3.

5. The method of claim 4, wherein the solid glass electrolyte comprises at least 50 wt % of dipole.

6. The method of claim 1, further comprising:
charging the electrochemical cell via a charge current; and
discharging the electrochemical cell after charging via a discharge current.

7. The method of claim 6, wherein the electrochemical cell exhibits a self-cycling component of the charge current or discharge current.

8. The method of claim 6, comprising operating the electrochemical cell for at least a thousand charge/discharge cycles.

9. A method of operating an electrochemical cell, the method comprising:
charging an electrochemical cell via a charge current;
discharging the electrochemical cell via a discharge current, the electrochemical cell comprising:
a solid glass electrolyte comprising:
an alkali metal working ion that is conducted by the electrolyte; and
a dipole;
an anode; and
a cathode,
wherein one or both of the cathode and anode substantially lack the working ion prior to initially charging or discharging the electrochemical cell, and
wherein the electrochemical cell exhibits a self-cycling component of the charge current or discharge current.

10. The method of claim 9, wherein both the cathode and the anode substantially lack the working ion prior to the initial charge or discharge of the electrochemical cell.

11. The method of claim 9, wherein the working ion is lithium ion (Li⁺), sodium ion (Na⁺), or potassium ion (K⁺), or any combinations thereof.

12. The method of claim 9, wherein the dipole has the general formula A_{y}X_{z} or the general formula A_{y-1}X_{z}^{-q}, wherein A is Li, Na, K, Mg, and/or Al, X is S and/or O, 0<z≤3, y is sufficient to ensure charge neutrality of dipoles of the general formula A_{y}X_{z}, or a charge of −q of dipoles of the general formula A_{y-1}X_{z}^{-q}, and 1≤q≤3.

13. The method of claim 12, wherein the solid glass electrolyte comprises at least 50 wt % of dipole.

14. The method of claim 9, comprising operating the electrochemical cell for at least a thousand charge/discharge cycles.

15. An electrochemical cell comprising:
a solid glass electrolyte comprising:
an alkali metal working ion that is conducted by the electrolyte; and
a dipole;
an anode; and
a cathode,
wherein one or both of the cathode and anode substantially lack the working ion prior to initially charging or discharging the electrochemical cell.

16. The electrochemical cell of claim 15, wherein both the cathode and the anode substantially lack the working ion prior to the initial charge or discharge of the electrochemical cell.

17. The electrochemical cell of claim 15, wherein the working ion is lithium ion (Li⁺), sodium ion (Na⁺), or potassium ion (K⁺), or any combinations thereof.

18. The electrochemical cell of claim 15, wherein the dipole has the general formula A_{y}X_{z} or the general formula A_{y-1}X_{z}^{-q}, wherein A is Li, Na, K, Mg, and/or Al, X is S and/or O, 0<z≤3, y is sufficient to ensure charge neutrality of dipoles of the general formula A_{y}X_{z}, or a charge of −q of dipoles of the general formula A_{y-1}X_{z}^{-q}, and 1≤q≤3.

19. The electrochemical cell of claim 18, wherein the solid glass electrolyte comprises at least 50 wt % of dipole.

20. The electrochemical cell of claim 15, wherein the electrochemical cell has a charge/discharge coulomb efficiency of greater than 100%.

21. The electrochemical cell of claim 15, wherein the electrochemical cell exhibits an alternating current having a period of at least one minute.

22. The electrochemical cell of claim 15, wherein the electrochemical cell exhibits an alternating current having a period of at least one day.
